(19) United States
(12) Patent Application Publication
(10) Pub. No.: US 2018/0331404 A1
(43) Pub. Date: Nov. 15, 2018

(54) SYSTEMS AND METHODS FOR SOLAR POWER VAPOR RECOVERY

(71) Applicant: Valin Corporation, San Jose, CA (US)

(72) Inventors: James N. Slama, Lakewood, CO (US); Kevin E. Goodsell, Spring, TX (US); Steven T. Croft, Scotts Valley, CA (US)

(21) Appl. No.: 15/593,789

(22) Filed: May 12, 2017

(51) Int. Cl. H01M 10/63; F16L 53/00; H01M 10/48; H01M 10/658

(52) U.S. Cl. CPC H01M 10/63; H01M 10/658; H01M 10/486; F16L 53/008

(57) ABSTRACT

Systems and methods for recovering and re-using vented gas are disclosed. Wellhead devices and oil tanks vent gasses that may be captured and pressurized to be used again. Solar power generators may also reduce emissions. A vacuum tank and a control valve may control the flow of vented gas. The vented gas may be re-pressurized and sent to a flair line, pipeline, or pneumatic devices.

### TECHNICAL FIELD

The present disclosure relates generally to vented gas recovery. Specifically, the present disclosure relates to capturing and depressurizing vented gas for reuse.

### BRIEF DESCRIPTION OF THE DRAWINGS

The written disclosure herein describes illustrative embodiments that are non-limiting and non-exhaustive. Reference is made to certain of such illustrative embodiments that are depicted in the figures described below.

FIG. 1 illustrates an oil and gas well using gas from two to actuate pneumatic devices, according to one embodiment.

FIG. 2 illustrates a gas capture system for wellhead devices, according to one embodiment.

FIG. 3 illustrates a prior art oil tank vapor controller.

FIG. 4 illustrates a solar powered oil tank vapor control system, according to one embodiment.

FIG. 5 is a functional block diagram of a programmable logic controller that may control the pressure monitors of FIGS. 2 and 4, according to one embodiment.

FIG. 6 is a flow chart of a method for regulating pressure in an oil tank, according to one embodiment.

FIG. 7 illustrates a pipeline heating system using direct current heat trace.

FIG. 8 illustrates a solar powered glycol heating system.

FIG. 9 illustrates a side view of a battery temperature management system, according to one embodiment.

FIG. 10A illustrates a cross-sectional planar view of a battery temperature management system, according to one embodiment.

FIG. 10B illustrates a cross-sectional side view of a battery temperature management system.

FIG. 11 illustrates a close up cross-sectional side view of a thermal heat sink of a battery temperature management system, according to one embodiment.

FIG. 12 illustrates a close up cross-sectional side view of a hinge of a battery temperature management system, according to one embodiment.

FIG. 13 illustrates a battery protection controller, according to one embodiment.

FIG. 14 is a flow chart of a method for prolonging the life of a battery by maintaining a target operating temperature and preventing damage from discharging the battery too much or too often. Many of the steps may be implemented in any order.

### DETAILED DESCRIPTION

Embodiments of the present disclosure provide systems, methods, and apparatus for improving the efficiency of oil and gas well systems. Some embodiments include gas capture and reuse systems, solar power systems, and thermal battery management systems.

Natural gas is extracted from deposits or reservoirs. Deposits rich in natural gas are commonly referred to as natural gas “fields.” Natural gas may also be found in significant quantities in oil fields or coal beds. To extract natural gas from a natural gas field, a well is drilled from the surface to the deposit or reservoir. Natural gas from the wellhead is processed to remove condensates, water, and impurities or contaminants. Additionally, the natural gas may be further processed to separate the different hydrocarbons that form natural gas.

A plurality of devices facilitate the processing and separation of natural gas and oil. Unfortunately, oil and gas wells are typically located in remote locations without electricity. Thus, there is a need to power the equipment at the remote site. Conventional systems, such as combustion generators consume sellable resources (e.g., gas or oil). Combustion generators also produce emissions that cause health and environmental risks. Another system uses pneumatic devices that operate with compressed air. However gas engines or electric motors are required to operate air compressors. These engines require fuel, expensive maintenance and lengthy permitting processes. Further, electric motors require expensive electric utility lines to the well, which is often in a remote location. Even if compressed air was available, it may be saturated with water and can freeze devices under extreme conditions. Also, if the compressed air mixes with residual gas from the well, an explosion may result.

As described herein, an oil and gas well may use pneumatic devices powered by gas from the well to reduce the need for combustion generators and air compressors. Using the gas from the well also reduces the risk of freezing because the gas is dry. Further, using the gas from the well reduces the possibility of air mixing with residual gas.

The pneumatic devices may be powered by natural gas supplied directly from a wellhead. For example, in some embodiments, natural gas from the wellhead may be piped to each pneumatic device. Because the deposits and reservoirs are deep below the Earth's surface, the natural gas contained therein is under enormous pressure. Thus, each of the pneumatic devices may receive naturally compressed gas. The pneumatic devices may convert the compressed gas into mechanical work. Pneumatic devices used at an oil or gas well may include control valves, reciprocating pumps, diaphragm pumps, and valve actuators.

However, these pneumatic devices also consume sellable resources. After the pneumatic devices use the high pressure gas to produce mechanical work, the pressure of the gas is reduced. Low pressure gas cannot be sold or used to power another pneumatic device. Therefore, typically the pneumatic devices vent the low pressure gas to the atmosphere. When these devices are operated or actuated natural gas is emitted to the atmosphere. The gasses from the wellhead are potent greenhouse gasses regulated by governmental agencies. To comply with regulations for reduced emissions, a gas capture system may be used.

A system for capturing vented gas may include a vent line configured to couple to a gas vent of a wellhead device to receive uncompressed gas. The vent line may couple the wellhead device to a low pressure or vacuum tank to store uncompressed gas from the wellhead device to allow uncompressed gas to flow from the gas vent to the vacuum tank. A compressor may be coupled to the vacuum tank to reduce pressure in the vacuum tank and recompress vented gas from the well head device. A pressure monitor may ensure the gas flows from the pneumatic devices to the vacuum tank. The pressure monitor may include a first pressure sensor or pressure indicating transmitter (PIT) to monitor the pressure in the vent line, and a second pressure sensor or PIT to monitor the pressure of the vacuum tank and transmit a signal to operate or stop the compressor to maintain a specific pressure level in the vacuum tank. A control valve may control an opening of the vacuum tank. For example, the pressure monitor may open the control valve when the first pressure sensor measures a vent line pressure that is greater than a vacuum line pressure as measured by the second pressure sensor, thus the pressure increase in the vent line is reduced and gas flow from the pneumatic device to the tank is maintained. The recompressed vented gas may be reused by a pneumatic device or sold.

Similarly, an oil tank vapor recovery system may capture gas for use or sale. In a typical oil tank, oil vapors build up, pressurizing the oil tank, and when a pressure set point is reached the vapor is piped to a flair and burned. An oil tank vapor recovery system may capture the gas. The gas may be used for operating pneumatic devices, sold, or properly disposed of.

An oil tank vapor recovery system may include a vent line configured to couple to a gas vent of an oil tank to receive vented gas. A buffer tank may receive the vented gas from the oil tank through the vent line. A compressor coupled to the buffer tank may reduce pressure in the buffer tank by removing received vented gas from the buffer tank. A holding tank coupled to the compressor may receive the vented gas when the compressor removes the vented gas from the buffer tank. A pressure valve that may control an outlet of the holding tank.

A pressure monitor may monitor the pressure of the buffer tank and the oil tank to control the direction of gas flow and reduce the possibility of oxygen entering the oil tank. The pressure monitor may include a first pressure sensor to monitor the pressure in the oil tank, and a second pressure sensor to monitor the pressure of the buffer tank. A control valve may control an opening of the vacuum or buffer tank based on measurements from the first and the second pressure sensors. For example, the control valve may open when the first pressure sensor measures an oil tank pressure that is greater than a buffer tank pressure as measured by the second pressure sensor.

The compressor and monitor may be solar powered. For example, a solar panel system may generate electricity from available sunlight and the compressor may operate using the generated electricity.

The solar panel system may also power other parts of the system. For example, a pipeline heating system may include a solar power generator. The solar power generator may include at least one photovoltaic panel, a battery in electrical communication with the photovoltaic panel, and a solar power controller to monitor the power produced by the photovoltaic panel and maintain a direct current power output. The pipeline heating system may also include direct current heat trace that runs along a pipeline. The direct current heat trace is in electrical communication with the solar power generator and transforms the direct current power output to thermal energy to heat the pipeline.

A glycol pump system may also be solar powered. A solar powered glycol pump system may include a solar power generator comprising at least one photovoltaic panel, a battery in electrical communication with the photovoltaic panel, and a solar power controller to monitor the power produced by the photovoltaic panel. A electric pump powered by the solar power generator may circulate glycol. However, at times the solar power may be insufficient to power the electric pump. Therefore a gas/pneumatic operated pump may be used in parallel with the electric pump to circulate glycol. In some embodiments, the gas/pneumatic pump may be a diaphragm pump

A distribution controller may direct the flow of glycol based on which glycol pump is used. The distribution controller may include a first valve to receive cool glycol and selectively actuate and direct glycol to either the electric pump or the gas/pneumatic operated pump.

In some embodiments, the distribution controller may include a fired glycol heater. The distribution controller may also include a second valve to receive glycol from one of the electric pump and the gas/pneumatic operated pump and distribute the glycol to a glycol heater. A process controller of the distribution controller may send signals that cause the valves to actuate.

Solar power generators, including those described above, often include a battery to provide power while solar energy is unavailable. However, the life of the battery may be shortened by a variety of factors including the depth of discharge during use, and extreme temperatures. Embodiments described herein provide a battery temperature management system comprising a box with insulated sidewalls, base-wall, and lid, the sidewalls, base-wall and lid coupled to form a cavity, the cavity sized to house at least one battery. This box may insulate the battery from exterior climates. A hinge may couple the lid to a first sidewall. An actuator coupled to a second sidewall may be configured to selectively open and close the lid. A thermal heat sink may be within the box. The thermal heat sink may be a fluid tank within the cavity may contain a fluid. The fluid tank may be adjacent to the base-wall. A thermal pad along a side of the fluid tank opposite the base-wall may transfer thermal energy between the fluid in the fluid tank and a battery placed within the cavity. A heater may selectively heat the fluid in the fluid tank.

The fluid functions as thermal storage. The thermal energy stored in the fluid will keep the batteries warm and reduce the chance of the batteries freezing. In some embodiments, the amount of thermal energy stored may be sufficient to keep the batteries warm for weeks without any additional external energy input to the fluid or batteries. Thus, a battery temperature management system may help protect and preserve a battery used in remote, cold locations.

A temperature controller may moderate the temperature of the cavity. The temperature controller may include a thermometer to measure a temperature of the at least one battery. A human machine interface may receive a user input indicating a specified temperature to maintain the battery. The temperature controller may also include a processor and a non-transitory computer-readable medium in communication with the processor. The non-transitory computer-readable medium may provide instructions that when executed by the processor cause the processor to perform operations for controlling the temperature of the box. For example, the operations may include determining a temperature via the thermometer and comparing the temperature to the user input. When the temperature reaches a high threshold value, the actuator may open the lid to cool the batteries. When the temperature reaches a low threshold value, the heater may heat the thermal storage liquid.

In some embodiments, a battery temperature management system may include battery depth of discharge protections. Excessive discharge can damage batteries. The battery temperature management system may use hardware and software methods for measuring depth of discharge. Based on depth of discharge the system may shut down and/or set an alarm (e.g., a low alarm and an lower shutdown). After the battery charge has increased due to charging the system may re-start automatically.

Aspects of certain embodiments described herein may be implemented as software modules or components. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that perform one or more tasks or implement particular abstract data types. A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media.

A human machine interface (HMI) may include a display, an attached computer, or the like. The computer storage media may contain one or more input/output interfaces that facilitate HMI. The input device(s) may include a keyboard, mouse, button, touch screen, light pen, tablet, microphone, sensor, or other hardware with accompanying firmware and/or software. The output device(s) may include a monitor or other display, printer, speech or text synthesizer, switch, signal line, graphical user interface, or other hardware with accompanying firmware and/or software. A display may enable the CPU to display data or information to a user in a human-readable format. The display may be any display device including a light emitting diode (LED), liquid crystal display (LCD), and others. The user may provide an input to the CPU to perform operations on database records, including sorting a group of records based on one or more fields where the fields of the records are to be sorted.

Any “communications network” or “network” disclosed herein may include a wide variety of network infrastructures. In some embodiments, a network is formed by coupling several nodes on an FPGA board. In other embodiments, the network may couple remote devices. Specifically, a network may incorporate landlines, wireless communication, optical connections, various modulators, demodulators, small form-factor pluggable (SFP) transceivers, routers, hubs, switches, and/or other networking equipment. The network may include communications or networking software, such as software available from Novell, Microsoft, Artisoft, and other vendors, and may operate using TCP/IP, SPX, IPX, SONET, and other protocols over twisted pair cables, coaxial cables, optical fiber cables, telephone lines, satellites, microwave relays, modulated AC power lines, physical media transfer, wireless radio links, and/or other data transmission “wires.” The network may encompass smaller networks and/or be connectable to other networks through a gateway or similar mechanism.

Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network. According to one embodiment, a database management system (DBMS) allows users to interact with one or more databases and provides access to the data contained in the databases.

Systems described herein may comprise one or more modules. A module may include all or portions of other elements of the system. The modules may run multiple operations concurrently or in parallel by or on one or more processors. Portions of the disclosed modules, components, and/or facilities are embodied as executable instructions embodied in hardware or firmware, or stored on a non-transitory, machine-readable storage medium. The instructions may comprise computer program code that, when executed by a processor and/or computing device, causes a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. Portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, and/or the like.

Embodiments may be understood by reference to the drawings, wherein like parts are designated by like numerals throughout. The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

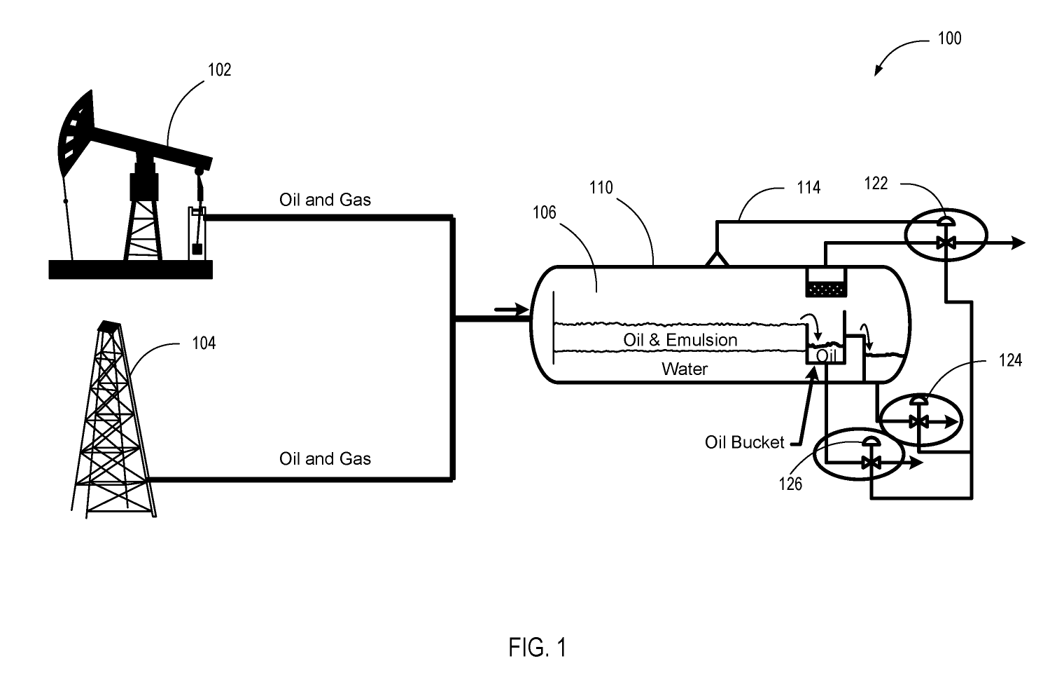

FIG. 1 illustrates an oil and gas well 100 using gas 106 from two wellheads (e.g., 102, 104) to actuate pneumatic devices (e.g., control valves 122, 124, and 126), according to one embodiment. As shown, oil and gas is pumped to the surface via the two wellheads 102, 104. The oil and gas is sent to a separator 110 where oil, gas and water are separated.

The oil, gas 106, and water levels of the separator 110 are maintained via control valves 122, 124, and 126. Natural gas direct from the wellheads 102, 104 is plumbed, via control lines 114, to each of the control valves 122, 124, and 126. In some embodiments, the gas 106 may go through a dehydration system before being sent to the control valves 122, 124, and 126. The gas 106 from the wellhead is pressurized from the depth of the oil reservoir. The pressure of the gas 106 provides sufficient energy to selectively actuate the control valves 122, 124, and 126. Once the gas 106 is used by the control valves 122, 124, and 126, the pressure of the gas 106 is reduced. The control valves 122, 124, and 126 may then vent the low pressure gas.

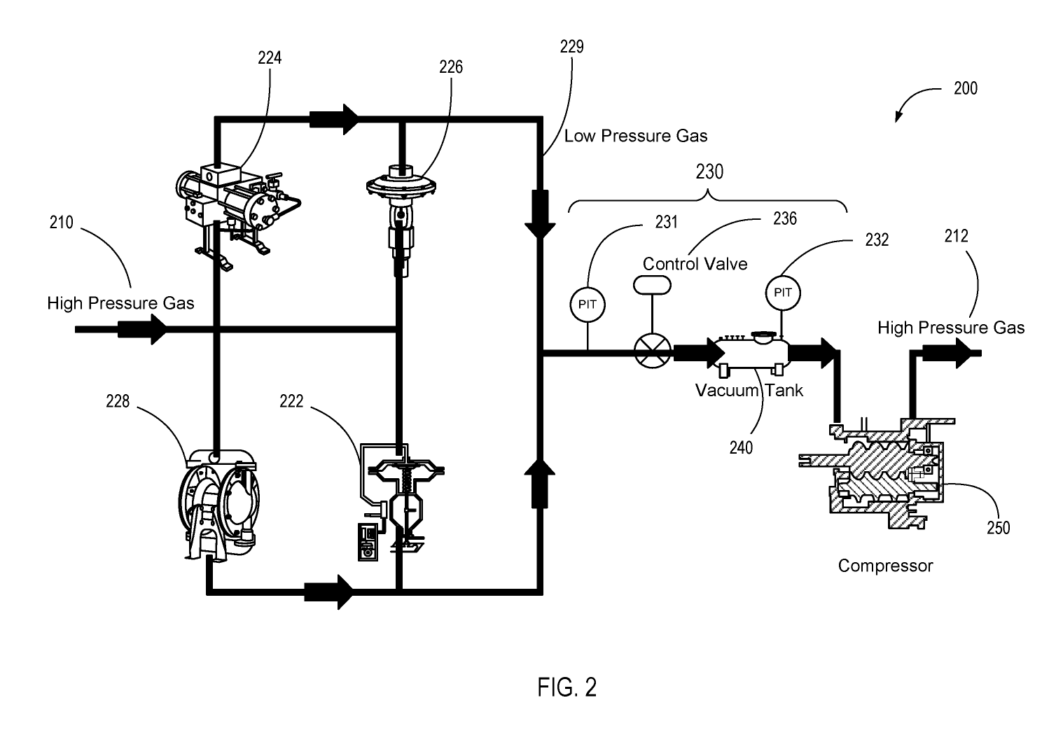

The vented gas may be emitted to the atmosphere. However, the vented gas comprises greenhouse gasses. Many government agencies have implemented regulations to reduce or eliminate the venting of greenhouse gasses to the atmosphere. Further, venting gas to the atmosphere reduces the amount of usable and sellable gas. A system to capture gas vented from wellhead devices (e.g., the gas capture system 200 of FIG. 2) would reduce emissions and increase the amount of usable gas.

FIG. 2 illustrates a gas capture system 200 for wellhead devices, according to one embodiment. As shown, the gas capture system 200 may include vent lines 229, a pressure monitor 230, a vacuum tank 240, and a compressor 250. The gas capture system 200 may capture vented gas from a plurality of wellhead devices (e.g., devices 224, 226, 228, and 222) and re-pressurize the gas for reuse. The re-pressurized gas may be used to operate pneumatic devices, sold, or disposed of.

The vent lines 229 may fluidly couple a gas vent of each wellhead device and the vacuum tank 240. For example, each of gas operated devices (e.g., devices 224, 226, 228, and 222) receives compressed gas from a supply line 210. The pressure energy from the compressed gas is used to operate the devices reducing the pressure of the gas. The gas is then released into the vent lines 229. The vent lines 229 direct the gas to the vacuum tank 240.

The direction of the flow of gas is determined by the pressure in the vent lines 229 as compared to the vacuum tank 240. If the vacuum tank 240 is kept at a lower pressure, the gas will flow away from the wellhead devices and toward the vacuum tank 240. In some embodiments, the vacuum tank 240 is kept at atmospheric pressure. In other embodiments, the vacuum tank 240 is held as a vacuum.

The compressor 250 maintains the pressure of the vacuum tank 240 and recompresses the vented gas. In some embodiments, the vented gas is piped directly to the compressor 250. In some embodiments, the compressor 250 may be solar powered. Using a solar powered compressor rather than a gas engine or electric motor reduces maintenance and fuel costs.

The pressure monitor 230 may monitor the pressure in the gas capture system 200 and control the flow of the vented gas. The pressure monitor 230 may include a first pressure sensor 231 to monitor the pressure in the vent line 229. A second pressure sensor 232 may monitor the pressure of the vacuum tank 240. The pressure monitor may control the flow of the vented gas via a control valve 236. The control valve 236 controls an opening of the vacuum tank 240. To maintain the flow of gas into the vacuum tank 240, the pressure monitor 230 closes the control valve 236 when the second pressure sensor 232 measures a vacuum tank 240 pressure that is greater than a vent line pressure as measured by the first pressure sensor 231. Further, the pressure monitor 230 may open the control valve 236 when the second pressure sensor 232 measures a vacuum tank 240 pressure that is less than a vent line pressure as measured by the first pressure sensor 231.

The gas capture system 200 may divert gas that has been re-compressed by the compressor 250 through a release line 212. In some embodiments, the release line 212 may couple to the supply line 210 and the re-pressurized gas may be re-used by the wellhead devices. In some embodiments, the release line 212 directs the gas to a pipeline to be sold. The compressor 250 may compress the gas such that the re-compressed gas has a pressure that matches the gas in the pipeline. In some embodiments, the release line 212 directs the gas to a thermal oxidizer for disposal.

In some embodiments the release line 212 may selectively send the gas to the wellhead devices, the pipeline, or the thermal oxidizer. For example, a second control valve may direct the flow of gas in the release line 212 and an oxygen sensor may monitor the oxygen levels in the gas. If oxygen is detected, the second control valve may direct the flow of gas to the thermal oxidizer. As another example, a pressure sensor may monitor the supply line 210. If a high pressure threshold is reached, the second control valve may direct the flow of gas to the pipeline.

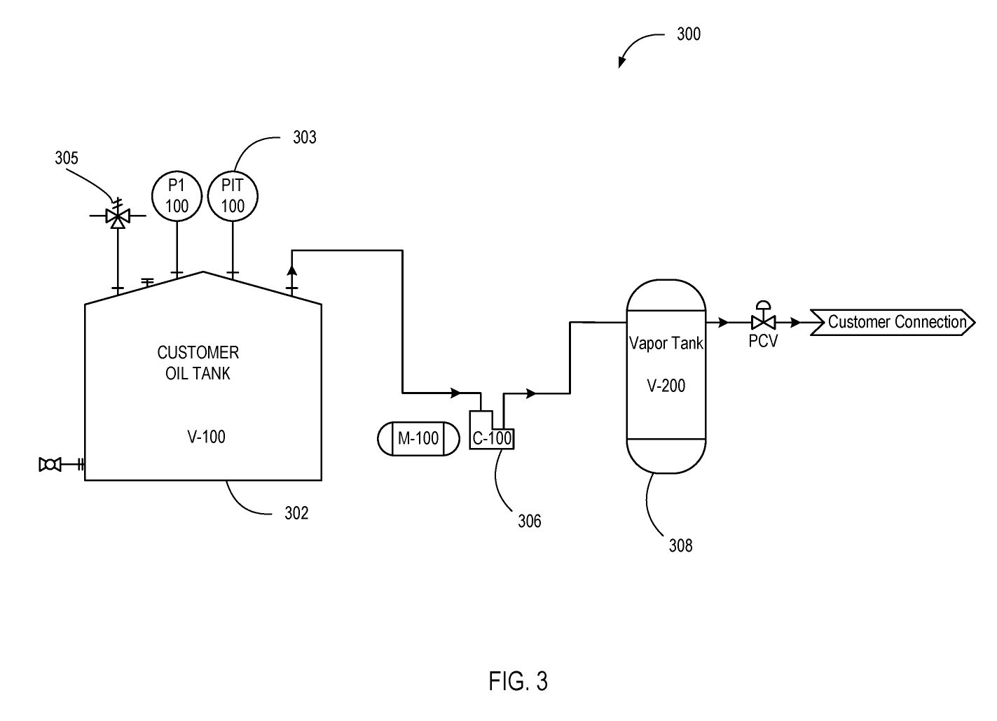

FIG. 3 illustrates a prior art oil tank vapor controller 300. The pressure inside an oil tank 302 increases when the tank is filled with oil and/or from the oil outgassing volatile organic compounds. The oil tank vapor controller 300 attempts to maintain a target pressure. The pressure in the oil tank 302 is monitored by a pressure sensor 303. Based on set pressure thresholds, the oil tank vapor controller 300 may relieve pressure or increase pressure.

For example, when pressure in the oil tank 302 is high, the oil tank vapor controller 300 may release the gas from the oil tank 302. For instance, a pressure vacuum relief valve PVRV 305 may have a pressure set point (PVRV setpoint) that includes a value indicating a high pressure. When the pressure exceeds the PVRV setpoint, the PVRV 305 opens and releases the gas to a flair, thermal oxidizer, or the atmosphere. This vented gas is an emission that is heavily regulated in an effort to reduce greenhouse gasses. The vented gas also represents lost revenue.

A second pressure set point (PLC setpoint) may include a value that is lower than the PVRV setpoint but still indicates a high pressure. When the pressure exceeds the PLC setpoint but not the PVRV setpoint, a compressor 306 reduces the pressure in the oil tank 302 and stores the gas in a vapor tank 308. Unfortunately, the compressor 306 cannot always keep up with changes in pressure in the oil tank 302, causing at least a portion of the gasses to be vented out the PVRV 305. Typically, the outlet of the PVRV is connected to a flair or thermal oxidizer. Further, the startup and shut down time of the compressor 306 creates imprecisions in pressure maintenance.

The gas in the vapor tank 308 may be sold or burned. However, if the pressure in the oil tank 302 is low and the gas from the vapor tank 308 is depleted, air is allowed to enter the PVRV 305. The gasses in the oil tank 302 when combined with oxygen can be potentially explosive.

A PVRV is a closable aperture on the tank. PVRVs are used to take samples of the tanks contents to determine the pressure level of the tank and protect the tank from over pressure and excessive vacuum. As excessive pressure builds up in the tank or vessel the PVRV cover lifts, breaking a seal and allowing excess pressure to dissipate into the atmosphere. It closes under gravity when the pressure has returned to normal. If the tank is subjected to negative pressure, the PVRV opens and allows air to be drawn into the vessel. The PVRV closes when a positive pressure is established. Thus, this solution of maintaining pressure either vents heavily regulated greenhouse gases or allows oxygen to enter the tank.

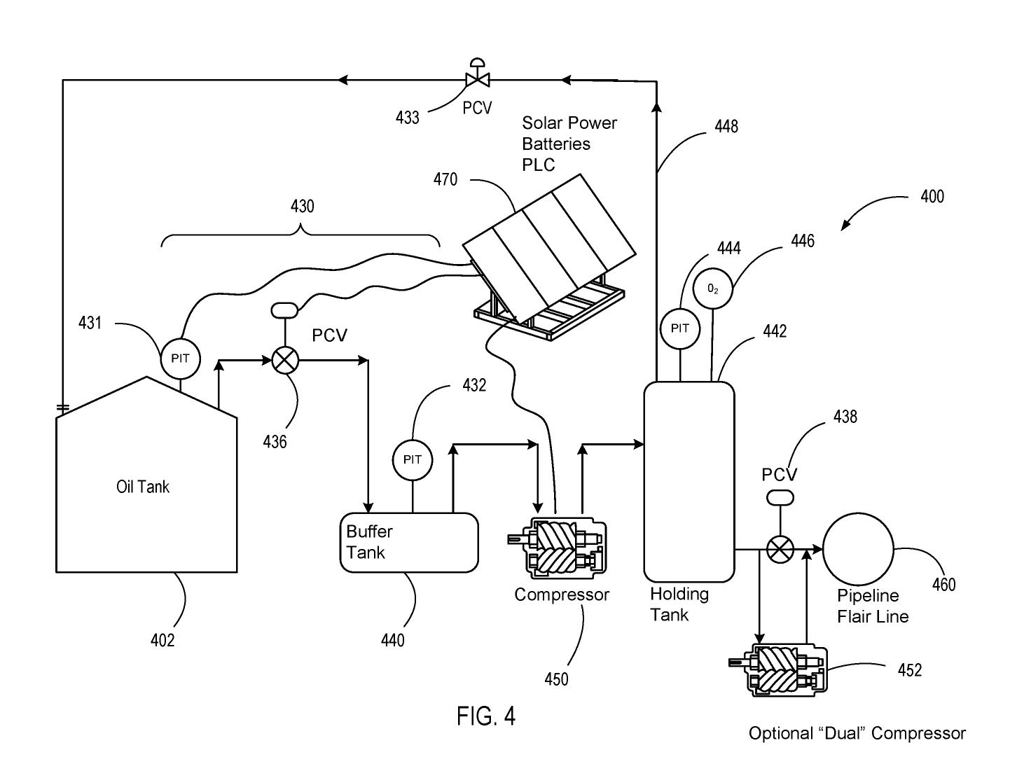

FIG. 4 illustrates a solar powered oil tank vapor control system 400, according to one embodiment. The solar powered oil tank vapor control system 400 reduces the emissions when compared to the prior art as shown in FIG. 3 by more precisely controlling pressure in an oil tank 402. The solar powered oil tank vapor control system 400 also prevents oxygen from entering the oil tank 402. As shown, the solar powered oil tank vapor control system 400 comprises a buffer tank 440, a compressor 450, a pressure monitor 430, and a holding tank 442. A pressure monitor 444 connected to holding tank 442, an 02 sensor 446 connected to holding tank 442, a return line 448 connected from tank 442 to oil tank 402 and an pressure control valve 433 connected to return line 448.

In some embodiments, the buffer tank 440 is maintained at a vacuum. In some embodiments, the buffer tank 440 is kept at atmospheric pressure. The buffer tank 440 provides an intermediate holding point for gasses vented from the oil tank 402. The buffer tank 440 facilitates the handling of large amounts of gas that the compressor 450 alone would not be able to handle. For example, when a large slug of oil enters the oil tank 402, this may rapidly change the pressure in the oil tank 402. A very large and expensive compressor would be needed to accommodate the rapid pressure change. However, with the buffer tank 440, the gas from the oil tank 402 may be quickly removed and placed in the buffer tank 440, thus maintaining the pressure in the oil tank even when the compressor 450 is not fast enough to handle the surge.

The pressure monitor 430 may provide precise control of the pressure in the oil tank 402. The pressure monitor 430 may monitor the pressure in the solar powered oil tank vapor control system 400 and control the flow of the vented gas. The pressure monitor 430 may include a first pressure sensor 431 to monitor the pressure in the oil tank 402. A second pressure sensor 432 may monitor the pressure of the buffer tank 440. The pressure monitor 430 may control the flow of the vented gas via a control valve 436. The control valve 436 controls an opening of the buffer tank 440. Because low pressure is maintained in the buffer tank 440, opening the control valve 436 causes the gas to flow from the oil tank 402 to the buffer tank 440. Further, by using a valve and a low pressure tank, the response time is minimal (e.g., valve actuation time is significantly shorter than compressor start-up time).

To maintain the flow of gas into the buffer tank 440, the pressure monitor 430 closes the control valve 4306 when the second pressure sensor 432 measures a buffer tank pressure that is greater than an oil tank pressure as measured by the first pressure sensor 431. Further, the pressure monitor 430 may open the control valve 436 when the second pressure sensor 432 measures a buffer tank pressure that is less than an oil tank pressure as measured by the first pressure sensor 431. In some embodiments, when the pressure in the tank 402 is reduced vapor from the holding tank 442 can be directed through the return line 448 into the oil tank 402. The return line PCV 433 can open or close resulting in maintaining a target pressure in the tank 402 without allowing air to enter the tank 402.

The compressor 450 may maintain the low pressure of the buffer tank 440, and move the gas into the holding tank 442. When pressure builds in the holding tank 442, a pressure valve 438 opens and allows gas to exit the holding tank 442. In some embodiments, the gas is sent to a pipeline 460 to be sold. In some embodiments, the gas is sent to a flair line for disposal. In some embodiments an oxygen sensor in the holding tank 442 may monitor for a threshold oxygen level. If the threshold oxygen level (e.g., 5% of the gas concentration) is reached, the gas is sent to a flair line, but if the oxygen level stays below the threshold the gas is sent to the pipeline 460 to be sold.

In some embodiments, the solar powered oil tank vapor control system 400 may include dual-compressors (e.g., compressors 450 and 452). The first compressor 450 maintains low pressure in the buffer tank 440 and transfers gas to a low pressure intermediate storage tank (e.g., holding tank 442). The second compressor 452 may compress the gas in the holding tank 442 to a high enough pressure for injection into the pipeline 460 (e.g., 100-150 psi), or liquefaction of hydrocarbons for storage in a tank for future removal from site. For example, at room temperature and with an approximate pressure of 150 psig, propane is compressed into a liquid. Therefor it is possible to manufacture propane (NGLs) on site. The second compressor 452 may allow for the regulation of gas pressures from an array of oil tanks.

As shown, a solar power generator 470 may power components of the solar powered oil tank vapor control system 400. The solar power generator 470 may include at least one photovoltaic panel, a battery in electrical communication with the photovoltaic panel, and a solar power controller to monitor the power produced by the photovoltaic panel and maintain a direct current power output. In some embodiments, the solar power generator 470 powers the low power equipment like the pressure sensors 431, 432 and control valve 436. In some embodiments, the solar power generator 470 may power the first compressor 450. For example, the first compressor 450 may be a high efficiency screw compressor to maximize the power output of the solar power generator 470, while the second compressor 452 may be powered via another source. In some embodiments, a supplemental generator may provide additional power.

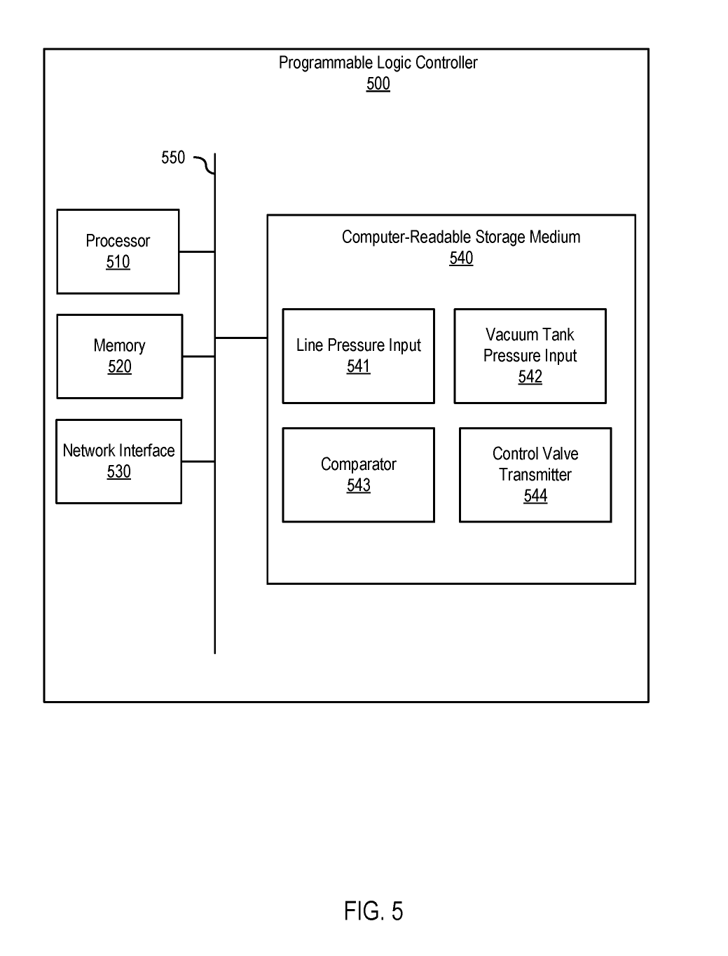

FIG. 5 is a functional block diagram of a programmable logic controller 500 that may control the pressure monitors 230, 430 of FIGS. 2 and 4, according to one embodiment. The programmable logic controller 500 may include a processor 510, a memory 520, a network interface 530, and a computer-readable storage medium 540. A bus 550 may connect the processor 510 to the computer-readable storage medium 540, the memory 520, and the network interface 530.

The memory 520 may include a device configured to electronically store data (e.g., computer-readable instructions). For example, the memory 520 may be volatile data storage (e.g., random access memory (RAM)), non-volatile data storage (e.g., Flash memory, a hard drive, a solid state drive, electrically programmable read-only memory (EPROM)), other data storage, or combinations thereof.

The network interface 530 interconnects the programmable logic controller 500 with external devices, systems, and networks. For example, the network interface 530 may communicatively couple the programmable logic controller 500 to a monitoring station. The network interface 530 may be configured to transmit and/or receive information by physical (wireline) and/or wireless communications links.

The computer-readable storage medium 540 may be a non-transitory device, according to one embodiment, and include any number of modules 541-546 for estimating an admittance matrix. In some embodiments, one or more of the modules 541-546 may be implemented in software, hardware, and/or firmware. In some embodiments, one or more of the modules 541-544 may be implemented in a cloud based or remote location and interface via a communication interface, such as the network interface 530.

The computer-readable storage medium 540 is in communication with the processor through the bus 550. Each of the modules 541-544 provides instructions that when executed by the processor 510 cause the processor 510 to perform operations for estimating an admittance matrix. The modules 541-544 may include a line pressure input 541, a vacuum tank pressure input 542, a comparator 543, and a control valve transmitter 544.

The line pressure input 541 and the vacuum tank pressure input 542 may receive signals from pressure sensors on a gas capture system. The signals may provide sampled pressure values at two points in the gas capture system. These points may include prior to a control valve and after the control valve. The comparator 543 compares the two signals. Based on the compared signals, the control valve transmitter 544 sends a signal to the control valve to open or close.

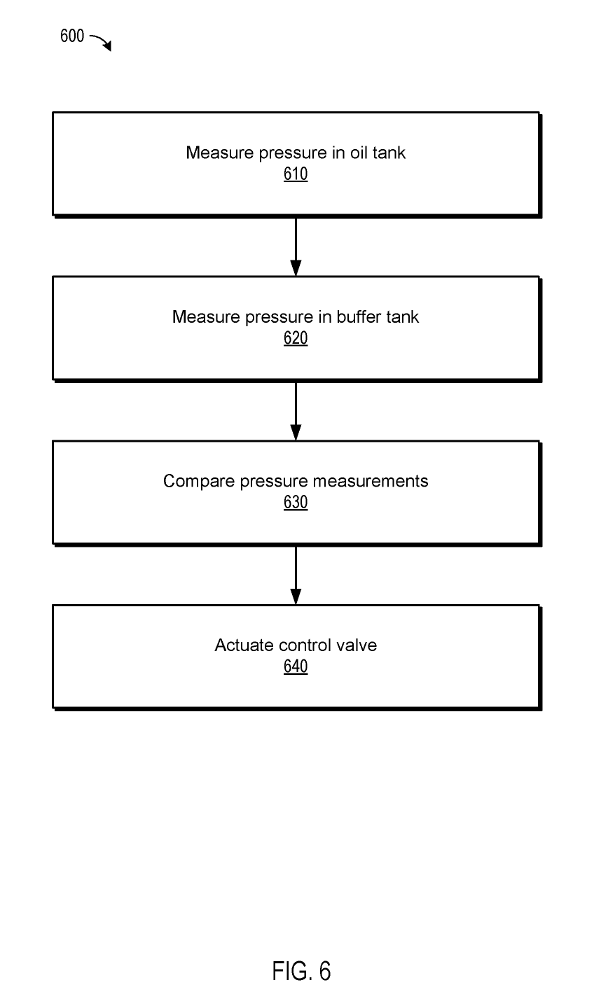

FIG. 6 is a flow chart of a method 600 for regulating pressure in an oil tank, according to one embodiment. Many of the steps may be implemented in any order. However, as illustrated, a first step may include using a pressure sensor measuring 610 the pressure in an oil tank. A pressure sensor may measure 620 pressure in a buffer tank. A pressure regulating system may compare 630 the measurements, and actuate 640 a control valve if certain states are present. For example, if the pressure in the oil tank reaches a high threshold, the control valve may open to allow gas to flow to the buffer tank. The control valve may close when the pressure in the control tank reaches a target threshold, or when the pressure in the buffer tank exceeds the pressure of the oil tank. When the pressure in the tank reaches a set point the compressor is turned on in order to maintain a specific pressure in the tank.

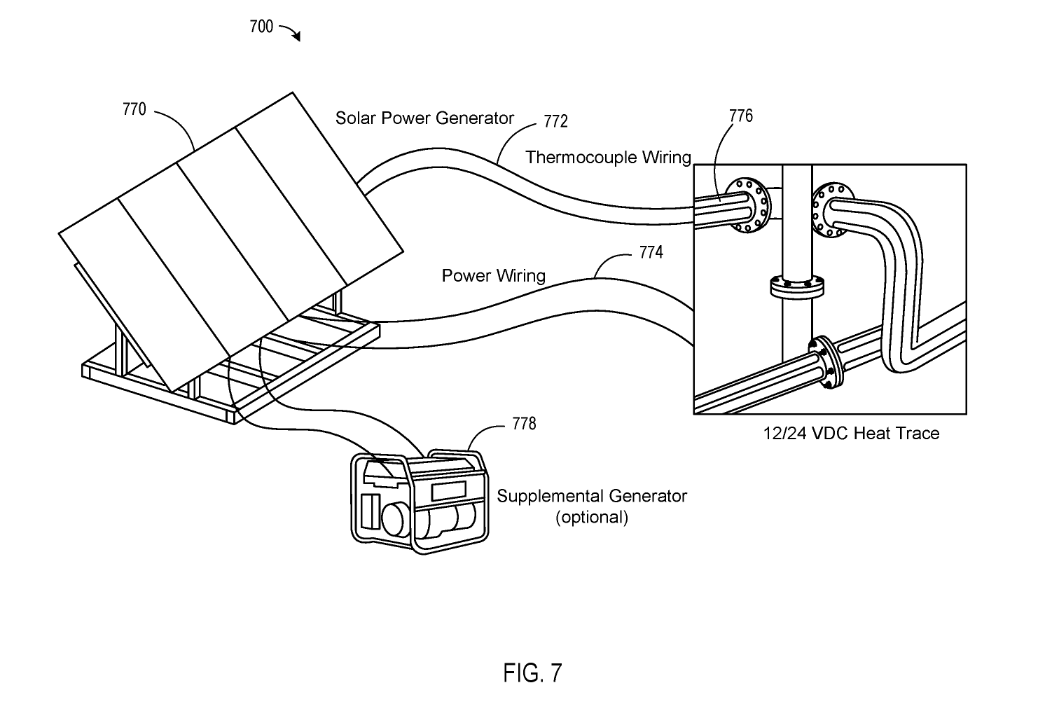

FIG. 7 illustrates a pipeline heating system 700 using direct current heat trace 776. The pipeline heating system 700 may include a solar power generator 770. The solar power generator 770 may include at least one photovoltaic panel, a battery in electrical communication with the photovoltaic panel, an a solar power controller to monitor the power produced by the photovoltaic panel and maintain a direct current power output.

The pipeline heating system 700 may also include direct current heat trace 776. The direct current heat trace 776 may be placed along a pipeline, and electrical communication with the solar power generator 770. As show, the solar power generator 770 may couple to the direct current heat trace 776 through power wiring 774. The direct current heat trace 776 may transform the direct current power output of the solar power generator 770 to thermal energy to heat the pipeline. Because the heat trace operates on direct current, a direct current to alternating current is not required.

A temperature transmitter, such as thermocouple wiring 772, may facilitate temperature control. For example, a user may set a target temperature or temperature range using an HMI. When a target temperature is set the solar power generator 770 may adjust the direct current output based on the temperature feedback from the thermocouple wiring 772 to achieve the target temperature.

In some embodiments, the pipeline heating system 700 may include a supplemental generator 778. The supplemental generator 778 may provide additional power if the solar power generator 770 does not provide enough power.

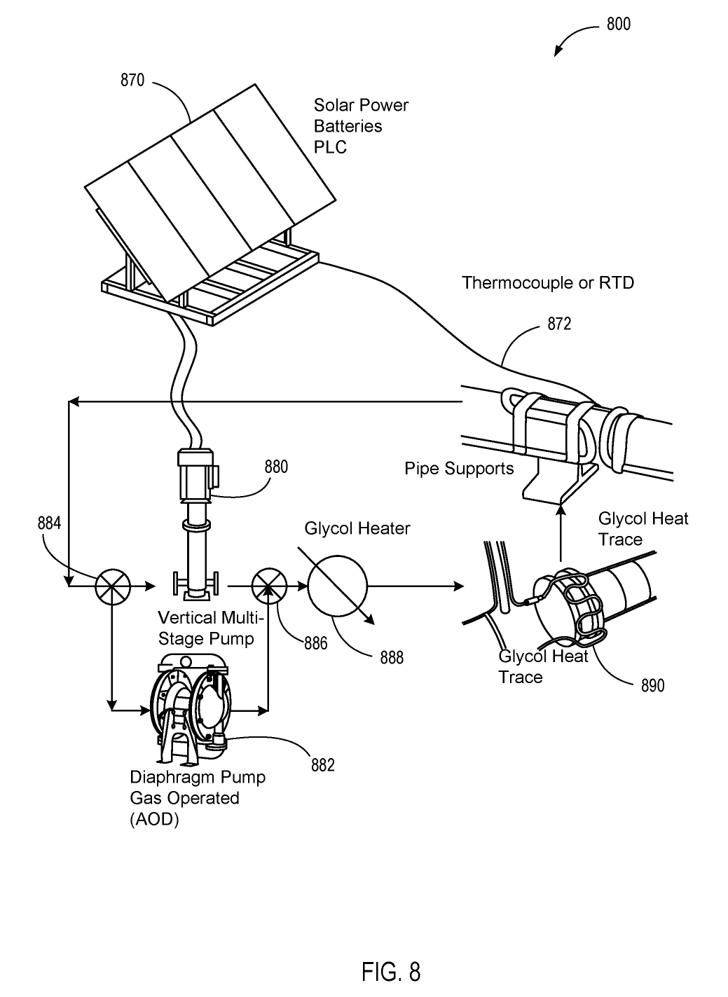

FIG. 8 illustrates a solar powered glycol heating system 800. The solar powered glycol heating system 800 may include a solar power generator 870, an electric pump 880, a diaphragm pump 882, and a glycol heater 888. In some embodiments, the electric pump 880 may be a vertical multi-stage centrifugal pump. The pumps 880, 882 circulate glycol through the glycol heater 888 and a glycol heat trace 890 to heat piping. The temperature of the glycol may be tracked via thermocouple wiring 872.

The diaphragm pump 882 and electric pump 880 may operate in parallel to increase availability of the system. A pair of valves 884, 886 switch automatically between the pumps 880, 882 based on demand and availability of compressed gas and solar power. The valves 884, 886 may be may check valves, servo valves, or other suitable valves. The diaphragm pump 882 may operate using compressed air or compressed gas. If compressed gas is used, the gas capture system 200 of FIG. 2 may capture and recycle gas vented from the diaphragm pump 882.

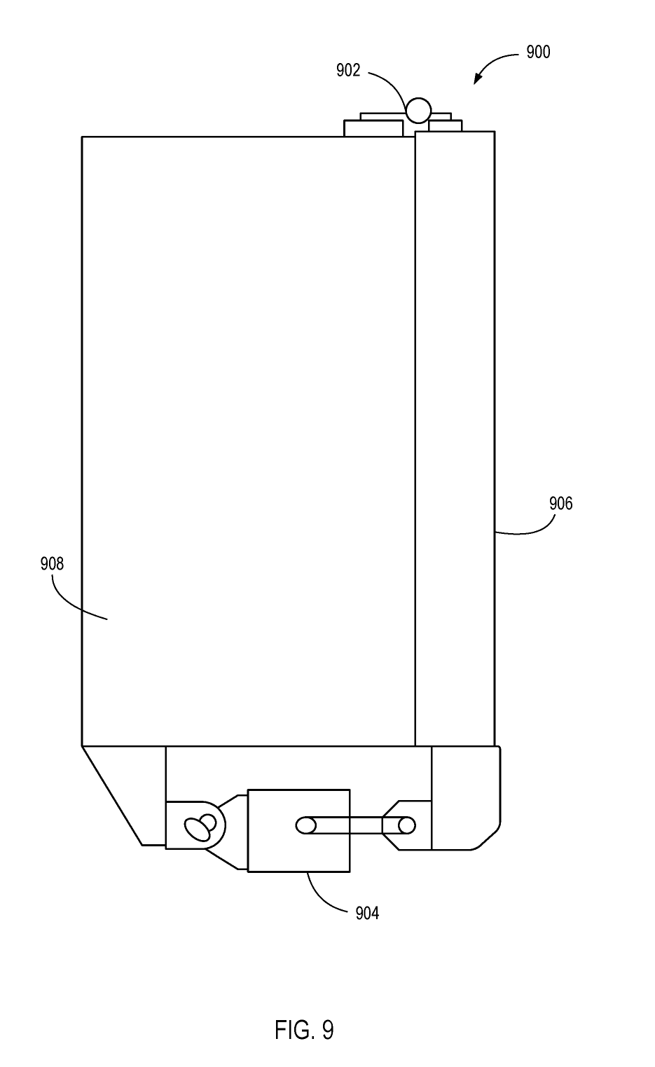

FIG. 9 illustrates a side view of a battery temperature management system 900, according to one embodiment. A shown, the battery temperature management system 900 may comprise a storage compartment 908, a lid 906, a hinge 902, and an actuator 904. The lid 906 and the storage compartment 908 may be coupled by the hinge 902.

The actuator 904 may selectively move the lid 906 between an open position and a closed position. In the closed position, the lid 906 and the storage compartment 908 form a sealed container with a cavity sized to store at least one battery. The lid 906 and the storage compartment 908 are insulated to passively maintain thermal energy of a stored battery. In some embodiments, polyisocyanurate is used to insulate the container. For example, the sidewalls, base, and lid may be six inches wide and lined with polyisocyanurate.

The battery temperature management system 900 may be programmed to automatically maintain stored batteries at a specific temperature. For example, the battery temperature management system 900 may include an HMI such as a touchscreen for a user to enter a target temperature. A temperature controller of the battery temperature management system 900 may make adjustments to the system to maintain the batteries at the target temperature. For example, when the temperature of a stored battery exceeds the target temperature, the temperature controller may send a signal to the actuator 904 to open the lid. Additionally, in some embodiments, the battery temperature management system 900 includes a fan that may provide forced convection cooling. Similarly, when the temperature of the stored battery is less than the target temperature, the temperature controller may send a signal to the actuator 904 to close the lid. Additionally, in some embodiments, the battery temperature management system 900 includes a heater to increase the temperature of the stored battery.

The heater may operate periodically to maintain the temperature. For example, the heater may operate hourly, daily, or weekly based on the thermal storage capacitance of the system. In some embodiments additional sources of thermal energy may be located within the cavity. For example, an electric motor compressor or a pump may be placed within the battery temperature management system 900.

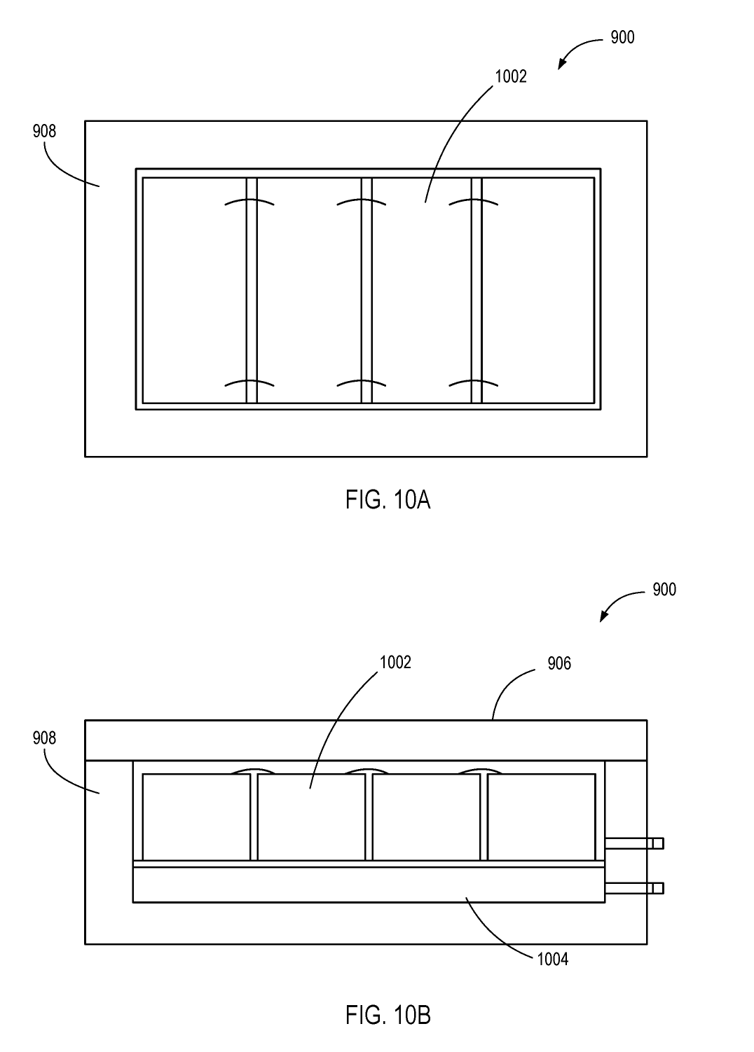

FIG. 10A illustrates a cross-sectional planar view of a battery temperature management system 900, according to one embodiment. As shown, the storage compartment 908 may house a plurality of batteries 1002. FIG. 10B illustrates a cross-sectional side view of a battery temperature management system 900. The battery temperature management system 900 may comprise a thermal heat sink 1004. In some embodiments, the thermal heat sink 1004 may comprise a fluid tank filled with a material with a high thermal capacity such as water, glycol, or wax. The thermal heat sink 1004 may be used to store thermal energy from a heater or from the batteries 1002.

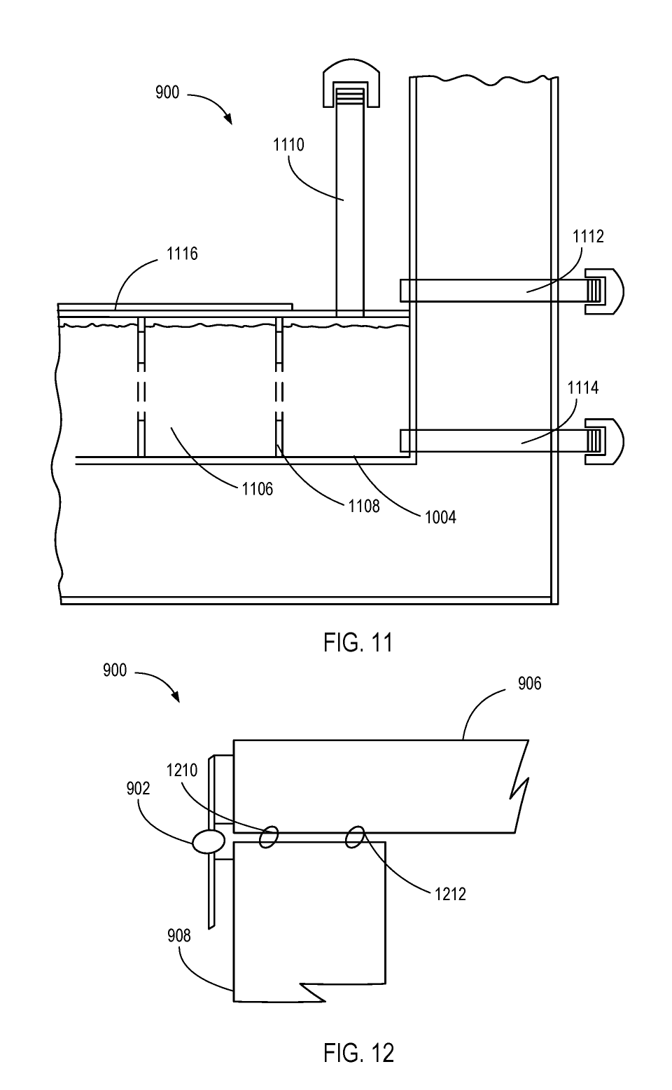

FIG. 11 illustrates a close up cross-sectional side view of a thermal heat sink 1004 of a battery temperature management system 900, according to one embodiment. As shown, the thermal heat sink 1004 may be a fluid storage tank comprising a material 1106 with a high thermal capacitance. The high thermal capacitance of the material 1106 may provide heat for the battery temperature management system 900 for an extended period of time. Supports 1108 within the thermal heat sink 1004 may provide structural support for a battery to be placed on top. The supports 1018 may also transfer thermal energy to within the thermal heat sink 1004

For example, if a heater 1116 of the battery temperature management system 900 is powered by solar energy, during a storm or low sunlight, the thermal energy from the heater may not be available. The material 1106 may provide heating during low solar periods by storing thermal energy that was provided by the heater 1116 when solar energy was available. In some embodiments, the material 1106 may be water, glycol, or wax.

Heater 1116 may be a thermal pad that converts electric power into thermal energy. Solar power and/or batteries may provide electric power to the heater 1116. The temperature of the heater 1116 may be controlled based on a target battery temperature for the batteries stored within the temperature management system 900. In some embodiments, the batteries stored within the temperature management system 900 may provide power to the heater 1116.

Drains 1112, 1114 may protect the batteries from fluid damage. For example, the bottom drain 1114 may drain a portion of the material 1106 in the thermal heat sink 1104 based on pressure in the thermal heat sink 1104. The top drain 1112 may drain any fluids out of a battery storage compartment of the battery temperature management system 900.

FIG. 12 illustrates a close up cross-sectional side view of a hinge 902 of a battery temperature management system 900, according to one embodiment. As shown, the hinge 902 may couple the lid 906 to the storage compartment 908. Two gaskets 1210, 1212 may provide a seal to retain thermal energy within the storage compartment 908.

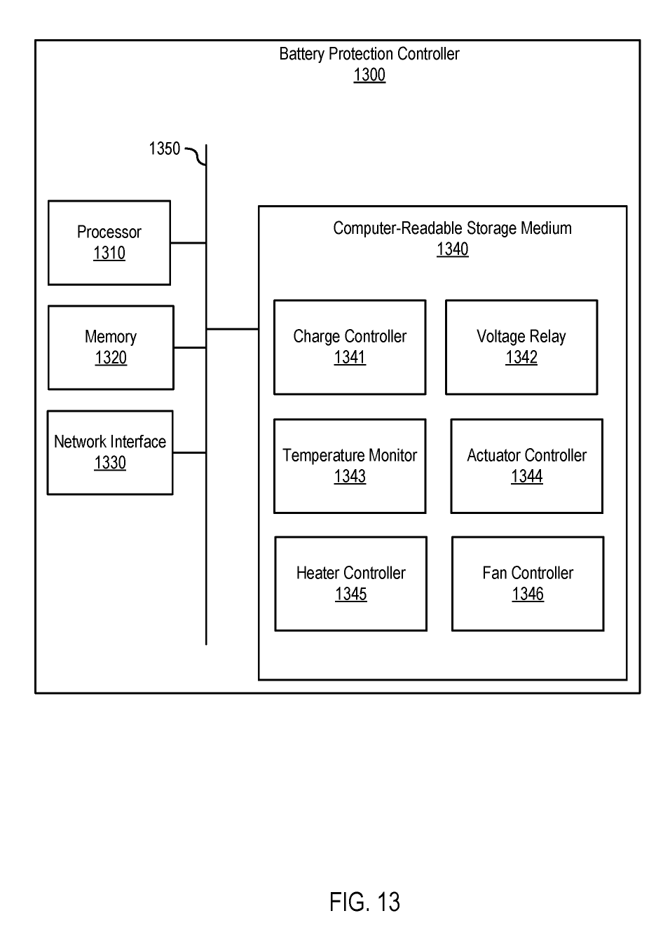

FIG. 13 illustrates a battery protection controller 1300, according to one embodiment. The battery protection controller 1300 may provide protection to lengthen a battery's life. For example, the battery protection controller 1300 may facilitate the temperature monitoring and control of the battery temperature management system 900 described with reference to FIG. 9. The battery protection controller 1300 may also monitor voltage to protect against depth of discharge damage.

The battery protection controller 1300 may include a processor 1310, a memory 1320, a network interface 1330, and a computer-readable storage medium 1340. A bus 1350 may connect the processor 1310 to the computer-readable storage medium 1340, the memory 1320, and the network interface 1330.

The memory 1320 may include a device configured to electronically store data (e.g., computer-readable instructions). For example, the memory 1320 may be volatile data storage (e.g., random access memory (RAM)), non-volatile data storage (e.g., Flash memory, a hard drive, a solid state drive, electrically programmable read-only memory (EPROM)), other data storage, or combinations thereof.

The network interface 1330 interconnects the battery protection controller 1300 with external devices, systems, and networks. For example, the network interface 1330 may communicatively couple the battery protection controller 1300 to a monitoring station. The network interface 1330 may be configured to transmit and/or receive information by physical (wireline) and/or wireless communication links.

The computer-readable storage medium 1340 may be a non-transitory device, according to one embodiment, and include any number of modules 1341-1346 for estimating an admittance matrix. In some embodiments, one or more of the modules 1341-1346 may be implemented in software, hardware, and/or firmware. In some embodiments, one or more of the modules 1341-1346 may be implemented in a cloud based or remote location and interface via a communication interface, such as the network interface 1330.

The computer-readable storage medium 1340 is in communication with the processor through the bus 1350. Each of the modules 1341-1346 provides instructions that when executed by the processor 1310 cause the processor 1310 to perform operations for estimating an admittance matrix. The modules 1341-1346 may include a charge controller 1341, a voltage relay 1342, a temperature monitor 1343, an actuator controller 1344, a heater controller 1345, and a fan controller 1346.

The charge controller 1341 may provide a first protection against depth of discharge damage. The charge controller 1341 communicates a battery voltage to a PLC. The PLC then compares the measured voltage to a set point voltage. If the measured voltage is less than the set point the PLC shuts down the process/load until a voltage reset level is reached to ensure the batteries are fully charged before operation begins again. An alarm may also be sent to a monitoring station to alert a technician of the event.

The voltage relay 1342 may provide a second protection against depth of discharge damage. The voltage relay 1342 may receive a relay voltage threshold. In some embodiments the relay voltage threshold is a factory set value. The relay voltage threshold may be lower than the voltage threshold for the charge controller 1341. The relay may interrupt the flow of electricity for one or all of the batteries to prevent further depth of discharge damage. An alarm may also be sent to a monitoring station to alert a technician of the event.

A temperature monitor 1343 may track the temperature of the batteries and compare the tracked temperature to a desired battery temperature. For example, if ideal operating temperature for a battery is 77 degrees Fahrenheit, the temperature monitor may compare a current battery temperature to the ideal.

If the current battery temperature does not match the ideal temperature, the actuator controller 1344, the heater controller 1345, and the fan controller 1346 may send signals that cause various equipment changes to maintain the temperature. For example, the actuator controller 1344 may send a signal to open or close a lid on a battery temperature management system. The heater controller 1345 may send a signal to operate a heater in a battery temperature management system. Similarly, the fan controller 1346 may send a signal to operate a fan in a battery temperature management system.

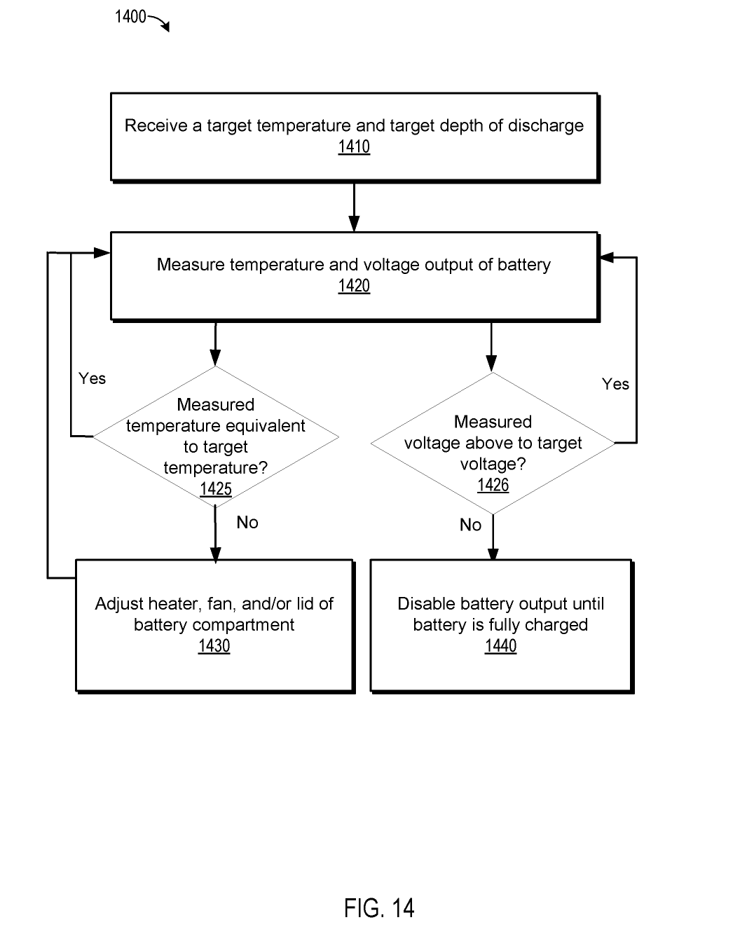

FIG. 14 is a flow chart of a method 1400 for prolonging the life of a battery by maintaining a target operating temperature and preventing damage from discharging the battery too much or too often. Many of the steps may be implemented in any order. However, as illustrated, a first step may include receiving 1410 a target temperature and target depth of discharge. A system using this method may measure 1420 the temperature and voltage output of the battery. The depth of discharge may be based on the voltage output. The measured and target temperature and voltage output may be compared 1425, 1426. When the target and measured temperatures do not match, an adjustment 1430 to the heater, fan, and/or lid of a battery compartment may be made. When the voltage falls below the target depth of discharge, the battery may be disabled 1440 until it is fully charged to prevent damage.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified.

The embodiments disclosed herein may be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the embodiments and methods of the disclosure are not intended to limit the scope of the disclosure, as claimed, but are merely representative of possible embodiments of the disclosure. In addition, the steps of a method do not necessarily need to be executed in any specific order, or even sequentially, nor need the steps be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Embodiments may be provided as a computer program product including a non-transitory computer and/or machine-readable medium having stored thereon instructions that may be used to program a computer (or other electronic device) to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable media suitable for storing electronic and/or processor executable instructions.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims are hereby expressly incorporated into this Detailed Description, with each claim standing on its own as a separate embodiment. This disclosure includes all permutations of the independent claims with their dependent claims.

It will be apparent to those having skill in the art that changes may be made to the details of the above-described embodiments without departing from the underlying principles of the invention. Embodiments of the invention in which an exclusive property or privilege is claimed are defined as follows.

What is claimed is:

1. A system for capturing vented gas comprising:
a vent line configured to couple to a gas vent of a wellhead device to receive uncompressed gas;
a vacuum tank to store uncompressed gas from the well head device, the vacuum tank coupled to the vent line to allow for uncompressed gas to flow from the gas vent to the vacuum tank;
a compressor coupled to the vacuum tank to reduce pressure in the vacuum tank and recompress vented gas from the well head device; and
a pressure monitor comprising:
a first pressure sensor to monitor the pressure in the vent line,
a second pressure sensor to monitor the pressure of the vacuum tank, and
a control valve controlling an opening of the vacuum tank, wherein the pressure monitor opens the control valve when the first pressure sensor measures a vent line pressure that is greater than a vacuum tank pressure as measured by the second pressure sensor.

2. The system of claim 1, wherein the pressure monitor closes the control valve when the first pressure sensor measures a vent line pressure that is less than a vacuum tank pressure as measured by the second pressure sensor.

3. The system of claim 1, further comprising a second vent line that receives high pressure gas from the compressor and provides the high pressure gas to at least one of a plurality of wellhead devices.

4. The system of claim 1, further comprising a second vent line that receives high pressure gas from the compressor and provides the high pressure gas to a pipeline.

5. The system of claim 1, further comprising a second vent line that receives high pressure gas from the compressor and provides the high pressure gas to a thermal oxidizer.

6. The system of claim 1, wherein the compressor is solar powered.

7. A pipeline heating system comprising:
a solar power generator comprising:
at least one photovoltaic panel,
a battery in electrical communication with the photovoltaic panel, and
a solar power controller to monitor the power produced by the photovoltaic panel and maintain a direct current power output; and
direct current heat trace to run along a pipeline, the direct current heat trace in electrical communication with the solar power generator, the direct current heat trace transforming the direct current power output to thermal energy to heat the pipeline.

8. The system of claim 7, further comprising:
a temperature controller; and
thermocouple wiring coupling the direct current heat trace to the temperature controller.

9. The system of claim 7, further comprising a supplemental generator.

10. An oil tank vapor recovery system comprising:
a vent line configured to couple to a gas vent of an oil tank to receive vented gas;
a buffer tank to receive vented gas from the oil tank, the buffer tank coupled to the vent line to allow for vented gas to flow from the gas vent to the buffer tank;
a compressor coupled to the buffer tank to reduce pressure in the buffer tank, by removing received vented gas from the buffer tank;
a holding tank coupled to the compressor to receive the vented gas when the compressor removes the vented gas from the buffer tank;
a pressure valve that controls an outlet of the holding tank;
a pressure monitor comprising:
a first pressure sensor to monitor the pressure in oil tank,
a second pressure sensor to monitor the pressure of the buffer tank, and
a control valve controlling an opening of the vacuum tank based on measurements from the first and the second pressure sensors, wherein the control valve opens when the oil tank pressure increases above a setpoint and the pressure of the buffer tank is less than the setpoint;
a return line fluidly coupling the holding tank to the oil tank; and
a control valve that controls gas flow within the return line, the control valve allowing gas to flow to maintain oil tank pressure.

11. The system of claim 10, further comprising:
a solar power generator comprising:
at least one photovoltaic panel,
a battery in electrical communication with the photovoltaic panel, and
a solar power controller to monitor the power produced by the photovoltaic panel,
wherein the solar power generator provides power to the compressor.

12. The system of claim 11, further comprising an auxiliary generator to provide power to the compressor when the solar power generator fails to provide operational power.

13. The system of claim 10, further comprising a second compressor coupled to the outlet of the holding tank.

14. The system of claim 10, wherein the outlet of the holding tank is coupled to a pipeline.

15. The system of claim 10, wherein the outlet of the holding tank is coupled to a thermal oxidizer.

16. The system of claim 10, further comprising an oxygen sensor to detect oxygen in the holding tank.

17. The system of claim 16, wherein the pressure valve diverts the vented gas in the holding tank to a thermal oxidizer if oxygen is detected in the holding tank.

18. The system of claim 17, wherein the pressure valve diverts the vented gas in the holding tank to a pipeline if oxygen is not detected in the holding tank.

19. The system of claim 10, wherein the buffer tank is kept at atmospheric pressure.

20. The system of claim 10, wherein the buffer tank is a vacuum tank.

21. A fluid pump comprising:
a solar power generator comprising:
at least one photovoltaic panel,
a battery in electrical communication with the photovoltaic panel, and
a solar power controller to monitor the power produced by the photovoltaic panel;
an electric pump powered by the solar power generator, the electric pump to circulate fluid;
a pneumatic pump to circulate fluid; and
a distribution controller comprising:
a first valve to receive fluid and selectively actuate and direct fluid to one of the electric pump and the pneumatic pump,
a second valve to receive fluid from one of the electric pump and the pneumatic pump and distribute the fluid to a heater, and
a process controller to operate the first and second valves.

22. The system of claim 21, wherein the process controller monitors the power output by the solar power generator, and when the solar power generator outputs power sufficient to operate the electric pump, the process controller actuates the first and the second valve to direct fluid through the electric pump.

23. The system of claim 21, further comprising an auxiliary generator to provide supplemental power to the electric pump.

24. A battery temperature management system comprising:
a storage compartment comprising insulated sidewalls, base-wall, and lid, the sidewalls, base-wall, and lid coupled to form a cavity, the cavity sized to house at least one battery;
a hinge coupling the lid to a first sidewall;
an actuator coupled to a second sidewall and configured to selectively open and close the lid;
a thermal heat sink within the cavity;
a thermal pad along a side of the thermal heat sink configured to generate thermal energy that is transferred to the cavity and the thermal heat sink; and
a temperature controller comprising:
a thermometer to measure a temperature of the at least one battery,
a human machine interface to receive a user input indicating a specified temperature,
a processor, and
a non-transitory computer-readable medium in communication with the processor, the non-transitory computer-readable medium providing instructions that when executed by the processor cause the processor to perform operations for controlling the temperature of the box, comprising:
determining a temperature via the thermometer,
comparing the temperature to the user input,
opening the lid, via the actuator, when the temperature reaches a high threshold value, and
operating the heater when the temperature reaches a low threshold value.

25. The system of claim 24, wherein the storage compartment is insulated with a plastic thermal insulation.

26. The system of claim 24, the temperature controller further comprising a voltage sensor to monitor an output of the at least one battery.

27. The system of claim 26, wherein the operations of the non-transitory computer-readable medium further comprise:
receiving a voltage threshold that indicates a target depth of discharge of the battery;
determining the voltage threshold has been reached; and
stopping an output of the at least one battery.

28. The system of claim 27, wherein the operations of the non-transitory computer-readable medium further comprise:
receiving a relay threshold that indicates a degrading depth of discharge of the battery, wherein the relay threshold is a lower voltage value than the voltage threshold;
determining the relay threshold has been reached; and
transmitting a signal to a relay to trip a circuit breaker controlling the flow of electricity from the at least one battery.

29. The system of claim 24, wherein the human machine interface is a touchscreen.

30. The system of claim 24, wherein the thermal heat sink comprises internal supports to support a battery.

31. The system of claim 30 wherein the internal supports are configured to conduct thermal energy.

32. The system of claim 24, wherein the thermal heat sink comprises a fluid tank filled with water.

33. The system of claim 24, wherein the thermal heat sink comprises a fluid tank filled with glycol.
